(19) United States
(12) Patent Application Publication
(10) Pub. No.: US 2009/0218831 A1
(43) Pub. Date: Sep. 3, 2009

(54) SECURITY DEVICES

(76) Inventor: Anthony Fitgerald Forde, Manchester (GB)

Correspondence Address: Workman Nydegger;1000 Eagle Gate Tower, 60 East South Temple, Salt Lake City, UT, 84111, US

(21) Appl. No.: 12/094,111

(22) PCT Filed: Nov. 17, 2006
(86) PCT No.: PCT/GB2006/004288

§ 371 Date: Sep. 4, 2008

(30) Foreign Application Priority Data
Nov. 18, 2005 (GB) 0523497.6
Oct. 12, 2006 (GB) 0620234.5

(51) Int. Cl. E05C 17/50

(52) U.S. Cl. 292/338

(57) ABSTRACT

There are provided security devices (1) for restricting the movement of a door. A device (1) comprises a blocking member (3) for extending into the path of the door and is carried by a housing (5). In use, the blocking member (3) can move between an active position in which it restricts movement of said door and an inactive position in which it does not restrict movement of said door. Also provided are door assemblies and methods of installing security devices and of operating security devices.

### FIELD OF INVENTION

The present invention relates to security devices, particularly to devices for restricting the movement of doors, to door assemblies incorporating such devices and to methods of installation and use of such devices.

### BACKGROUND TO INVENTION

Forced entry to premises by bogus callers who push their way in as a door is opened is a known problem. To alleviate this doors are often fitted with spy holes to allow identification to be checked before a door is opened. However, bogus callers often present false identification which can not be properly viewed via a spy hole. This can lead to a person opening the door so as to verify the bogus callers credentials. Alternatively, the bogus caller may invite the person into conversation which prompts them to open the door to allow better communication. The consequence of the person opening the door is that the property is left vulnerable to forced entry.

There are known a number of devices to limit the opening of a door. These are intended to hinder forced entry by a bogus caller whilst allowing a person to open a door sufficiently to check identification or talk to the caller. However, known devices are not without problems.

Door chains for example can be quite fiddly to use. This may be a particular problem for persons with arthritis.

In addition the attachment of the chain to the door and/or frame may not always be particularly strong. A bogus caller may thus be able to force the door open despite the chain.

Accordingly, the present invention aims to address at least one disadvantage associated with the prior art whether discussed herein or otherwise.

### SUMMARY OF THE INVENTION

According to a first aspect of the present invention there is provided a security device for restricting the movement of a door, wherein said device comprises a blocking member for extending into the path of the door and abuting said door to restrict movement of the door and wherein the blocking member is carried by a housing and is moveable relative to the housing such that, in use, the blocking member can move between an active position in which it restricts movement of said door and an inactive position in which it does not restrict movement of said door.

As used herein reference to “abuting a door” includes contact with a door component and/or attachment and/or fitting to a door, such as a kick plate for example, as well as with the body of a door itself.

Suitably, the housing of the device is arranged to be located to underlie the path of a door. The housing of the device may be arranged to be located below a door. Suitably, the device is arranged to be located relative to a door such that the door can pass over the blocking member when the blocking member is in the inactive position and such that the blocking member restricts the door from passing over the device when in the active position.

Suitably, there is provided a security device for restricting the movement of a door, wherein said device comprises a housing for locating below the path of the door and a blocking member for selectively extending into the path of the door and abuting said door to restrict movement of the door and wherein the blocking member is carried by the housing and is moveable relative to the housing such that, in use, the blocking member can move between an active position in which it restricts movement of said door and an inactive position in which it does not restrict movement of said door.

Suitably, the device is arranged such that it does not hinder movement of a door to a partially open position. Suitably though with the blocking member in the active position further movement of the door to a more open position may be substantially prevented.

Suitably, in use, the blocking member abuts a bottom part of a door when in the active position. Suitably, in use, the blocking member abuts an inner face of a door when in the active position.

The blocking member is suitably arranged to extend width wise relative to a door. Suitably, the blocking member is arranged to abut a door across at least 10% of its width, suitably at least 20%, for example across 50% or more of the doors width.

Suitably, the blocking member is arranged to extend substantially radialy relative to the rotational axis of the door.

Suitably, the device is arranged such that the blocking member extends above the housing when in the active position.

Suitably, the device is arranged such that the blocking member is substantially accommodated within the housing when in the inactive position.

The device may comprise a housing arranged to be mounted to a floor of a property on the interior side of a door. Alternatively, the device may comprise a housing forming or arranged to form part of a doorstep on the interior side of a door.

The housing may comprise a two part housing and may comprise a base and a cover.

Suitably, the blocking member is pivotally coupled to the housing. The blocking member may pivot to move substantially into the housing when in the inactive position and to move at least partially out of the housing when in the active position.

Suitably, the blocking member pivot is located on a side of the blocking member opposed to a side of the blocking member which is arranged to abut a door. Suitably, the blocking member is arranged such that if a force is applied to its side abuting a door, such as when an attempt is made to force the door open, that force is transmitted substantially radialy towards the blocking members pivot axis. In use if a bogus caller attempts to force the door open this may thus create substantially no turning force tending to move the blocking member. The blocking member may therefore remain in the active position resisting the forced entry.

Suitably, the blocking member comprises a wedge. The blocking member may comprise a wedge pivotally coupled to the housing by its thin end such that the opposed thick end is orientated to abut a door when in the active position.

Suitably, the blocking member is pivotally coupled to the housing by a hinge, suitably by a spring hinge.

Suitably, the device comprises means to limit movement of the blocking member relative to the housing. Said means may comprise a lip on the blocking member for engaging the housing. This may help to define the active position of the blocking member so that it may be optimised.

Suitably, the device comprises means for moving the blocking member between inactive and active positions.

Suitably, the device comprises actuating means for effecting movement of the blocking member from the inactive position to the active position.

Suitably, the actuating means comprises biasing means for biasing the blocking member towards the active position.

Suitably, the device comprises biasing means which comprises a spring. Suitably, the biasing means comprises a spring arranged to raise the blocking member into the active position. The biasing means may comprise a compression spring or torsion spring. Suitably, the biasing means comprises a plurality of springs.

The biasing means may comprise one or more springs of a spring hinge which hinge may pivotally couple the blocking member to the housing.

Suitably, the blocking member may be moved from the active to inactive positions by a user pressing against the force of the biasing means. Suitably, the user steps on the blocking member to return it into the housing.

Suitably, the actuating means comprises an actuating member for allowing movement of the blocking member to the active position.

Suitably, the actuating means comprises an actuating member which comprises a foot pedal. Suitably, the actuating member comprises a foot pedal arranged to move relative to the housing and blocking member. Suitably, the foot pedal is arranged to slide relative to the housing.

Suitably, the actuating means comprises an actuating member which is arranged to move between a first position in which it can retain the blocking member in an inactive position and a second position in which it can allow movement of the blocking member to the active position.

Suitably, the actuating member is biased towards the first position. Suitably, the actuating member is biased by a spring.

The device may comprise guide means, for example guide rails to guide movement of the actuating member. The guide rails may be provided by a guide member or may form part of the housing.

Suitably, the device comprises holding means to hold the blocking member in the inactive position against the bias of the biasing member until it is desired for the blocking member to move to the active position. Suitably, the actuating means comprises said holding means.

Suitably, the holding means comprises a part of an actuating member, suitably a foot pedal.

Suitably, the holding means comprises a tongue on the actuating member which is arranged to engage the blocking member. Suitably, said tongue engages a corresponding tongue on the blocking member to hold it in the inactive position.

Suitably, the actuating member and blocking member have tongues having cooperating surfaces such that movement of the blocking member from the inactive to active positions is prevented when the actuating member is in the first position.

Suitably, the actuating member and blocking member have tongues having cooperating surfaces such that movement of the blocking member from the active position towards the inactive position causes the actuating member to be displaced from the first position towards the second position to allow the blocking member to move to the inactive position with the actuating member then returning to the first position.

According to a second aspect of the present invention there is provided a door assembly comprising a door and a security device according to the first aspect.

Suitably, there is provided a door assembly comprising a door and a security device according to the first aspect wherein the housing of the device is located below the path of the door such that when the blocking member is in its active position it extends into the path of the door to restrict movement of the door and when the blocking member is in its inactive position the device does not hinder movement of the door.

Suitably the door comprises an inwardly opening hinged door.

The assembly may comprise any feature as described in relation to the first aspect.

According to a third aspect of the present invention there is provided a method of installing a security device according to the first aspect wherein the method comprises securing the housing of the device below the path of a door such that the door can pass over the device when the blocking member is in its inactive position and such that when the blocking member is in its active position it extends into the path of the door to restrict movement of the door.

The method may comprise installing the security device as part of a door step. The step may comprise an integral part of a door frame.

Alternatively, the method may comprise installing the security device onto or within a floor on the internal side of a door.

The method may comprise forming a recess in a floor and fitting. the housing such that at least a lower part thereof is accommodated into the recess. Alternatively, the housing may be fitted directly upon a floor without modification to the floor.

The method may comprise a method of installing a door assembly according to the second aspect.

According to a fourth aspect of the present invention there is provided a method of operating a security device according to the first aspect and/or a door assembly according to the second aspect.

Suitably, the method comprises a user (i) moving an actuating member to initiate movement of the blocking member from its inactive position to its active position before opening a door, then (ii) opening the door until it abuts the blocking member whilst the user verifies a callers identity then, once the identity is verified, (iii) moving the blocking member back to the inactive position to allow the door to be opened further.

Should the caller be identified as bogus step (iii) may not be performed. Instead, the door may be closed. If the bogus caller attempts to force the door open further the blocking member suitably resists movement of the door and may keep the premises secure.

### BRIEF DESCRIPTION OF DRAWINGS

The present invention will now be illustrated by way of example with reference to the accompanying drawings in which:

FIG. 1 is a perspective view of a security device abuting a door;

FIG. 2 is a perspective view of the security device of FIG. 1 with a door passing over;

FIG. 3 is a plan view of a housing of the security device of FIG. 1;

FIG. 4 is a plan view of an actuating member, blocking member and guide means of the security device of FIG. 1;

FIG. 5 is a perspective view of a blocking member;

FIG. 6 is a perspective view of an actuating member;

FIG. 7 is an exploded view of an alternative embodiment of a security device; and

FIG. 8 is a view of a spring hinge.

### DETAILED DESCRIPTION OF PREFERRED EMBODIMENTS

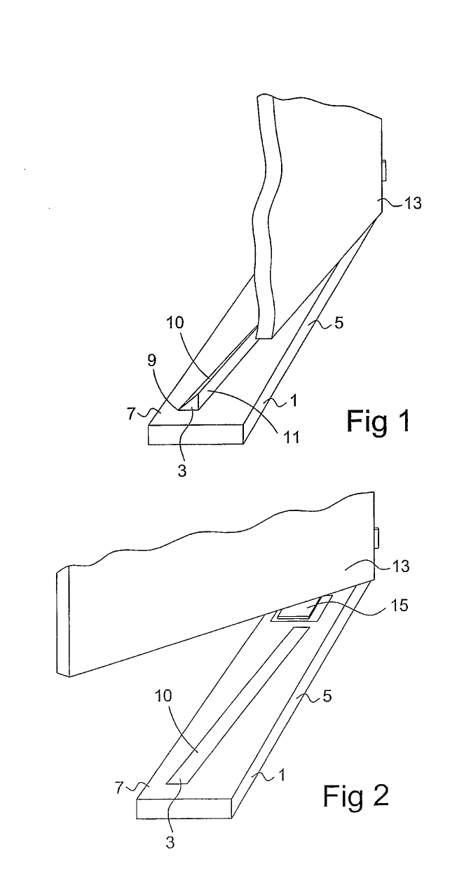

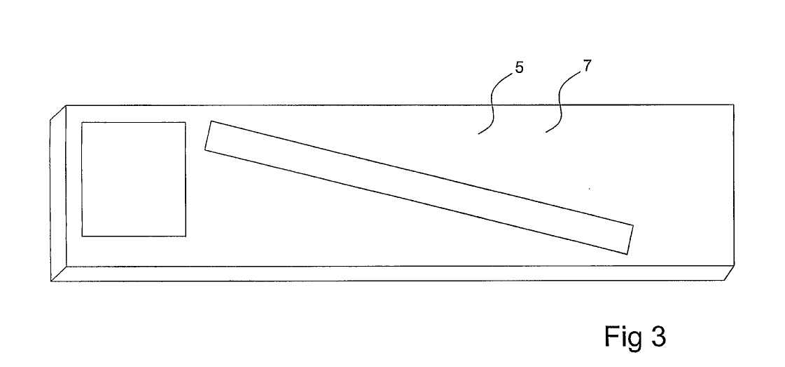

As illustrated by FIGS. 1 and 2 a security device 1 comprises a blocking member 3 carried by a housing (or chassis) 5. The blocking member is moveable between an active position (FIG. 1) in which it restricts movement of a door 13 and an inactive position (FIG. 2) in which it does not hinder movement of the door 13.

The device further comprises actuating means for moving the blocking member to the active position. This comprises an actuating member comprising a foot pedal 15. The actuating means also comprises a biasing member comprising a spring 12 (blocking member spring) for biasing the blocking member towards its active position. The pedal 15 is slidable relative to the housing 5 and can move between first and second positions. In use, moving the pedal 15 to the second position initiates movement of the blocking member to the active position. In the first position the pedal 15 can maintain the blocking member in the inactive position.

The housing 5 comprises a base tray (not shown) and a cover 7 and is arranged to be located below the path of a door. The cover 7 comprises apertures through which the blocking member 3 can extend and through which an actuating member comprising a foot pedal 15 can be accessed.

The blocking member 9 comprises a wedge pivotally coupled to the housing 5 cover by its thin end 9. The opposed thick end 11 faces a door 13 which it abuts when the blocking member is in the active position (FIG. 1).

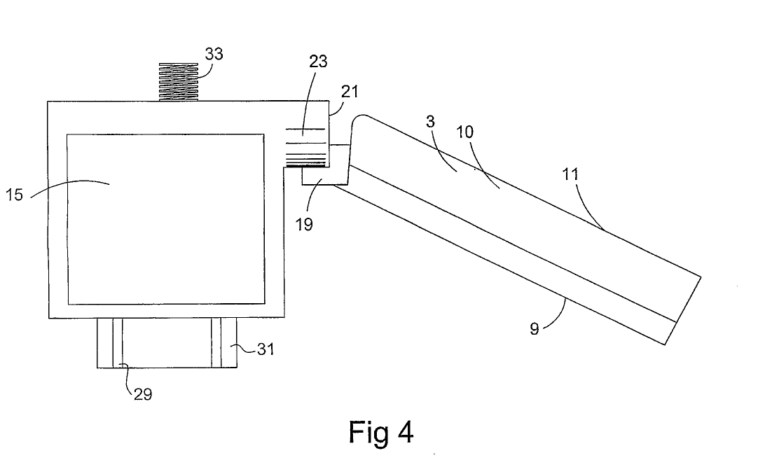

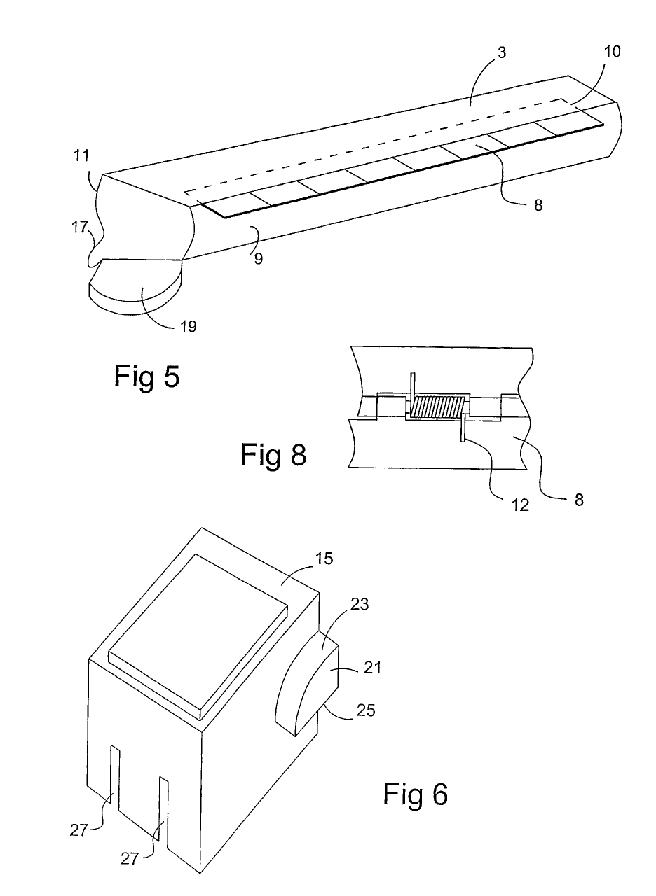

FIGS. 4 and 5 show the construction of the blocking member 3 in more detail. The blocking member 3 comprises a lip 17 provided on the side opposed to the pivot of the blocking member. This lip 17 engages the underside of the cover 7 of the housing 5 to limit movement of the blocking member 3 above the housing 5 and define its active position.

The pivot comprises a hinge 8 mounted to the blocking member 3 at it's thin end and to the cover 7 of the housing 5. The hinge is attached to the housing and blocking member by screws (not shown). As illustrated by FIG. 8 the hinge comprises a spring hinge which includes springs 12 (one shown). The springs 12 (one shown) comprise biasing members (blocking member springs) to bias the blocking member 3 towards the active position. The blocking member springs 12 to bias the hinge towards a position corresponding to the active position of the blocking member 3.

Located on the end of the blocking member 3 adjacent the foot pedal 15 is a tongue 19. This cooperates with a corresponding tongue 21 on the foot pedal 15 to provide holding means for maintaining the blocking member 3 in its inactive position.

FIGS. 4 and 6 show the construction of the actuating member, which comprises a foot pedal 15, in more detail. The foot pedal 15 has guide recesses 27 for receiving guide rails 29 which form part of a guide means comprising a pedal base 31 which couples to the housing base (not shown). In an alternative embodiment (not shown) the guide rails form part of the housing base. A compression spring 33 acts upon the pedal 15 and the housing base (not shown) to bias the pedal 15 to a first position in which it can retain the blocking member 3 in its inactive position.

The tongue 21 which engages the tongue 19 of the blocking member 3 has a chamfered upper face 23 and a flat lower face 25.

The shape of the lower face 25 of tongue 21 means that when the pedal 15 is in the first position (FIG. 4) the tongues 19, 21 resist the bias of the blocking member springs 12 and hold the blocking member 3 in the inactive position. To allow the blocking member 3 to rotate upwardly to the active position the pedal 15 must be moved to its second position (not shown) so as to disengage the tongues 19, 21.

The shape of upper face 23 of the tongue 21 means that if a force is applied to the blocking member 3 to rotate it downwardly towards the inactive position the actuating member 15 does not prevent this. As the blocking member 3 is moved towards the inactive position, its tongue 19 engages that of the actuating member 15 causing the actuating member to slide towards its second position against the bias of spring 33. Once the blocking member 3 is in the inactive position and the tongues 19, 21 have passed the spring 33 returns the actuating member 15 to its first position. The tongues thus once again engage so as to hold the blocking member 3 in its inactive position.

In use the device 1 is installed to underlie the path of a door as illustrated by FIGS. 1 and 2. The housing 5 is secured to the floor on the interior side of the door. In an alternative embodiment (not shown) the device is incorporated into a door step.

Before opening a door 13 to a caller a user slides the foot pedal 15 (actuating member) towards the door 13. This moves the pedal 15 from a first position, in which it holds the blocking member 3 in an inactive position against the bias of the blocking member springs 12. As the pedal 15 is moved into a second position (not shown) it no longer holds the blocking member 3 in place and the blocking member 3 pivots upwardly under the blocking member springs 12 bias. The blocking member 3 thus moves to its active position in which it extends above the housing 5 and lies in the path of the door 13. When a user releases their foot from the pedal 15 the pedal is returned to its first position by spring 33. The blocking member 3 remains in the active position held there by the bias of the blocking member springs 12.

The door 13 can now be opened and its lower edge will abut the thick edge 11 of the blocking member 3 as shown by FIG. 1. Any attempt to force the door will be transferred through the blocking member 3 to the pivot of the hinge 8 predominantly as a compression force. Thus, it will not cause the blocking member 3 to rotate back into the housing 5 and the forced entry will be resisted.

Once a caller's identity has been verified a user can press down on the upper face 10 of the blocking member 3 to rotate it back into the housing 5 and into its inactive position. To do this a user must apply pressure sufficient to overcome the bias of the blocking member springs 12 but this is not an arduous effort. As the blocking member 3 is moved into the housing the pedal 15 is displaced from its first position to its second position by engagement of the tongues 19, 21 of the pedal 15 and blocking member 3. As the blocking member 3 reaches its inactive position spring 33 returns the pedal 15 to its first position such that tongues 19, 21 engage to hold the blocking member 3 in place. The door can then pass over the blocking member 3 as shown by FIG. 2.

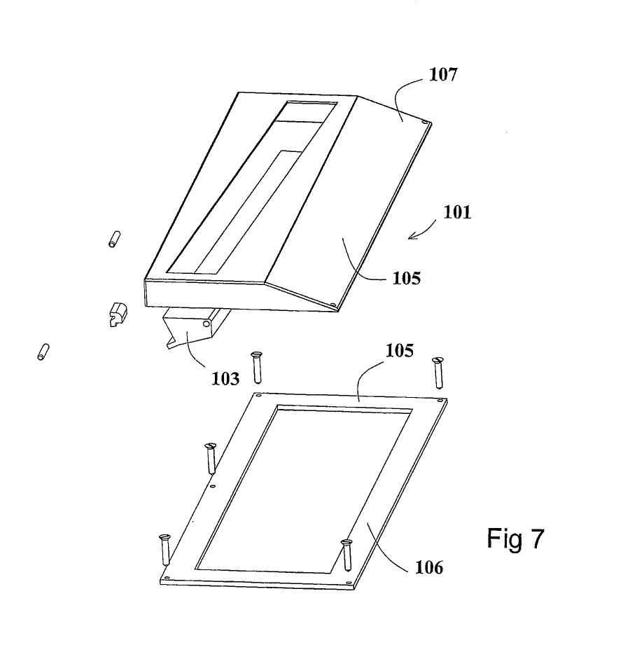

FIG. 7 shows an alternative embodiment of a security device 101. This comprises a housing (chassis) 105 comprising a cover 107 and a base comprising a frame 106. The housing 105 carries a blocking member 103 in the form of a wedge. The blocking member comprises pivots at its ends for engaging with the cover of the housing 105.

The blocking member 103 is activated by a user to restrict opening of a door. A blocking member spring (not shown) biases the blocking member 103 into an active position in which it extends above the housing 105.

The device 101 comprises actuating means comprising a pedal and lever assembly (not shown) which holds the blocking member in an inactive position until released by a user. The pedal is located to the side of the blocking member 103 so as to move the lever to control movement of the blocking member.

In use, to move the blocking member 103 to an active position a user slides the pedal which in turn causes movement of the lever to release the blocking member to move to the active position under the bias of the blocking member spring. A further spring then tends to return the pedal and thus lever to their initial position.

To return the blocking member 103 to the inactive position a user simply steps on it. The lever and pedal assembly are arranged so as to allow this movement of the blocking member 103 and then retain it in the inactive position until a user once again moves the pedal.

It will be appreciated that preferred embodiments of the present invention may provide a convenient security measure.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment (s). The invention extends to any novel one, or any novel combination, of the features disclosed in this specification (including any accompanying claims, abstract and drawings), or to any novel one, or any novel combination, of the steps of any method or process so disclosed.

1-28. (canceled)

29. In or for a door assembly, a security device for restricting the movement of a door, said device comprising:
a blocking member for extending into the path of the door and abutting said door to restrict an attempted opening movement of the door;
a housing;
means for mounting said blocking member in said housing so as to be carried by said housing;
means for mounting said housing and said blocking member, in use, adjacent said door such that the door can pass over the blocking member when the blocking member is in an inactive position but cannot pass over said blocking member when said blocking member is in an active, door-opening-restricting, position; and
means for enabling said blocking member to be moved, relative to said housing, by an operator such that, in use, and at the choice of said operator, said blocking member can move between its active position in which it restricts movement of said door and can move into or out of an inactive position in which it does not resist movement of said door.

30. The invention of claim 29, wherein said blocking member is arranged to extend substantially radially relative to the rotational axis about which said door, in use, opens.

31. The invention of claim 29, wherein said means for mounting said blocking member to said housing comprising pivot means and wherein said pivot means is located on a first side of said blocking member opposed to a second side of said blocking member which is arranged to abut said door.

32. The invention of claim 29, wherein said blocking member comprises an elongate wedge means.

33. The invention of claim 29, wherein there are provided actuating means for effecting movement of said blocking member from its inactive position to its active position, and wherein said actuating means comprises biasing means for biasing said blocking member towards its active position; said biasing means comprising a spring means arranged to raise said blocking member into its active position; said blocking member moving, in use, from its active to its inactive position by a user pressing against the force of said biasing means; and said actuating member comprising a foot-operable pedal.

34. The invention of claim 33, wherein said foot-operable pedal moves, in use, relative to said housing and said blocking member.

35. The invention of claim 33, wherein said foot-operable pedal is arranged for slidable movement relative to said housing and said blocking member.

36. The invention of claim 33, wherein said foot-operable pedal is separate from said blocking member.

37. The invention of claim 30, wherein said radius along which said blocking member extends subtends, with an edge of said door, an arc about said rotational axis of said door, thereby enabling said blocking member when in its active position to restrict movement of said door into but not beyond a partially opened position in which it abuts said blocking member whilst a user verifies a caller's identity.
